(19) United States
(12) Patent Application Publication
(10) Pub. No.: US 2002/0198016 A1
(43) Pub. Date: Dec. 26, 2002

(54) Simple hinge wireless mobile device flip enclosure

(76) Inventor: Sheel A. Gupte, Buffalo Grove, IL (US)

Correspondence Address: GREER, BURNS & CRAIN, 300 S WACKER DR, 25TH FLOOR, CHICAGO, IL, 60606, US

(21) Appl. No.: 09/887,946

(22) Filed: Jun. 22, 2001

(51) Int. Cl. H04B 1/38

(52) U.S. Cl. 455/550; 455/575; 455/90; 379/433.13

(57) ABSTRACT

A wireless mobile communication device enclosure of the invention includes a main part and flip part joined to permit opening and closing of said flip part. A hinged connection joins the main part and the flip part to permit said opening and closing of said flip part. The hinged connection includes a shaft accommodated within a housing. Rotation of the shaft relative to the housing deflects a leaf spring in the housing at a first relative rotational position of the shaft and said housing, and allows the leaf spring to relax, preferably to a completely undeflected state, at two additional relative rotational positions of the shaft relative to the housing.

### FIELD OF THE INVENTION

The field of the invention is wireless mobile communication device flip enclosures. A primary application of the invention is a “flip-phone”, a small portable phone or phone/data device that has two parts in hinged connection to each other.

### BACKGROUND OF THE INVENTION

For size and aesthetics, flip phones and devices are a popular form of wireless mobile communication devices. A hinge connecting a main part and a flip part of such devices is generally required to provide resistance from being moved from a fully open or fully closed position. It is also desirable for the hinge to assist reaching the completion of a movement of the flip part toward a fully open or fully closed position after providing initial resistance to movement.

Cost, simplicity, ease of assembly and small size are omnipresent concerns in the design and manufacture wireless mobile devices. The same concerns apply to the incorporation of a hinge in a flip style enclosure for a wireless mobile communication device. The concerns are exacerbated by the advancement of mobile communication devices. Incorporation of additional electronics and technology requires further cost and size optimization for other components.

Springs in hinges for flip enclosures must produce a reasonable amount of torque to assist the user. This has been addressed in the art with complex arrangements. Examples are disclosed in U.S. Pat. Nos. 5,111,503 and 5,257,301. There remains a need for an improved wireless mobile communication device enclosure.

### SUMMARY OF THE INVENTION

This need is addressed by the invention. A wireless mobile communication device enclosure of the invention includes a main part and flip part joined to permit opening and closing of said flip part. A hinged connection joins the main part and the flip part to permit said opening and closing of said flip part. The hinged connection includes a shaft accommodated within a housing. Rotation of the shaft relative to the housing deflects a leaf spring in the housing at a first relative rotational position of the shaft and said housing, and allows the leaf spring to relax at two additional relative rotational positions of the shaft relative to the housing.

### BRIEF DESCRIPTION OF THE DRAWINGS

Other features, objects and advantages will be apparent to those skilled in the art through reference to the detailed description and the drawings, of which:

FIG. 1 is an exploded perspective view showing a preferred wireless mobile communication device hinged enclosure of the invention; FIG. 2 is an exploded perspective view of the preferred hinge shown in FIG. 1; and

FIG. 3 is a cross section view taken through a portion of the shaft of FIG. 1 that aligns with the leaf spring shown in FIGS. 1 and 2.

### DETAILED DESCRIPTION OF THE PREFERRED EMBODIMENTS

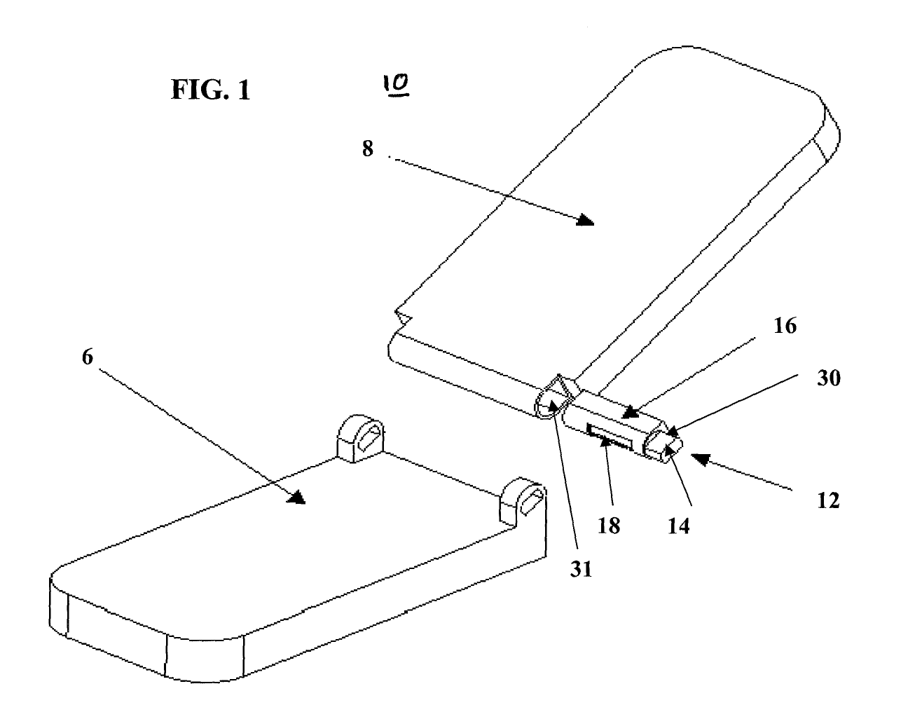

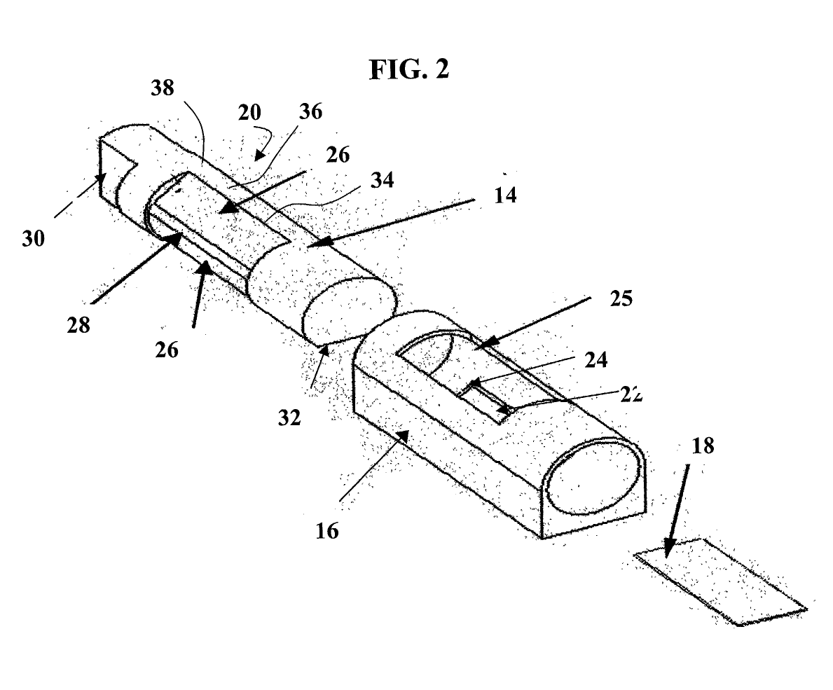

A main part 6 and flip part 8 are joined to form an enclosure 10 of the invention in FIG. 1, with an enlarged exploded view of a preferred hinged connection 12 of the invention shown in FIG. 2. The hinged connection 12 joins the main part 6 and flip part 8, provides sufficient torque, resistance to cycling failure, is simple, and meets stringent design space requirements. Length for embodiments of the present hinged connection may be limited to about three times the diameter of a shaft 14 used in the hinged connection 12.

The hinged connection 12 avoids the need for multiple hinges or springs, while providing the necessary initial resistance from movement away from the fully open or fully closed position and the assistance to complete movement toward the fully open and closed positions. The shaft 14 is closely accommodated within a housing 16, with the housing allowing for relative rotational movement between the shaft 14 and the housing 16. Free rotation of the shaft 14 is opposed by a leaf spring 18 held between the housing 16 and the shaft 14. A portion 20 of the shaft is configured to deflect the leaf spring 18 at a first relative rotational position of the shaft 14 and the housing 16. The portion 20 allows the leaf spring to relax at two additional relative rotational positions of the shaft 14 and the housing 16.

The portion 20 of the shaft 14 is preferably an integral part of the shaft 14 to further the goal of low component count and simplicity. Such a camshaft is easily shaped to attain the desired deflections at predetermined relative rotational positions. Some advantages of the invention might still be obtained by attaining the required shape for deflection of the leaf spring 18 through attachments to the shaft, though. The generally cylindrical opening in the housing 16 accommodates deflection of the leaf spring 18 in an accommodation space 22, which may be a recess or an opening. The leaf spring 18 is held in place by a shelf 24 in the housing 16 that is disposed around, preferably on two opposite sides along the major length, of the accommodation space 22. An opening 25 in the top of the housing 16 facilitates machining of the accommodation space 22 and shelf 24.

In the preferred embodiment, appropriate deflection and relaxation of the leaf spring 18 is attained due to two flattened portions 26 on cam-type shaft 14. The two flattened portions 26 end in a common ridge portion 28, and are axially aligned with the leaf spring 18 and the accommodation space 22. Rotational positions of the shaft 14 aligning the flattened portions 26 with the leaf spring 18 permit the leaf spring to relax, preferably to a completely undeflected position. These positions correspond to the fully open and fully closed positions of the flip part 8. Movement away from either the fully open or fully closed position is resisted initially by the leaf spring 18 because rotational positions of the camshaft 14 away from these positions begins to align the ridge 28 with the leaf spring 18 to cause deflection of the leaf spring 18 by contact with the ridge 28.

The ridge 28 preferably extends an entire length of the leaf spring 18, and has some significant width. This makes the contact region between the ridge 28 and the leaf spring 18 large. Maximizing contact regions between stressed moving parts reduces stresses and enables use of plastic parts, e.g., a plastic housing 16 and shaft 14, without sacrificing the ability to withstand a large number of use cycles. Fatigue testing beyond 30,000 cycles is generally an important design validation requirement for portable wireless devices. The ridge 28 is also rounded to facilitate smooth movement when it contacts and travels over the leaf spring 18. It is the contact between the ridge 28 and the leaf spring 18 that creates torques to oppose and assist movement of the flip part 8 relative to the main part 6. The amount of torque is primarily a function of the size and thickness of the leaf spring 18, the amount of deflection caused by the ridge 28, and the distance between the supported edges of the leaf spring 18 and the point at which the ridge 28 first contacts the leaf spring 18. These parameters may be easily chosen to suit particular desired amounts of torque.

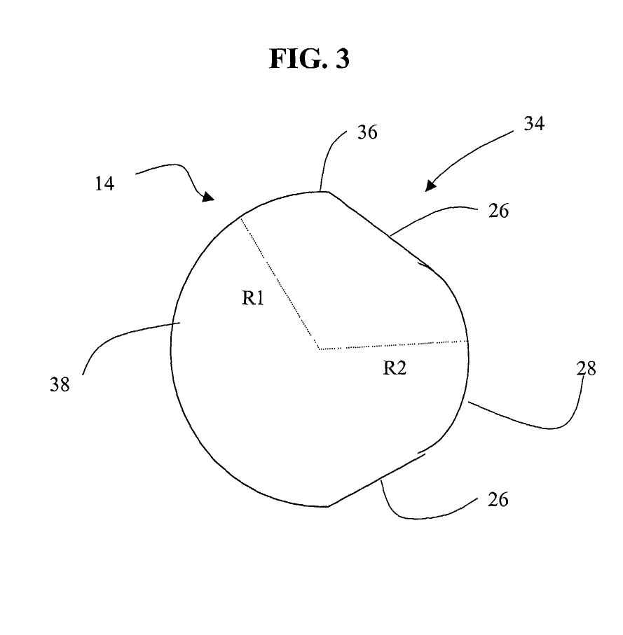

As seen in FIGS. 2 and 3, a portion 30 the shaft 14 extends beyond the housing 16. The housing 16 is, in FIG. 1, a separate part, which may be inserted into an opening 31 of the flip part. It might also be accommodated in the flip part 8. An alternative is for the housing 16 to form an integral part of one of the main part 6 or the flip part 8, i.e., part of the same molding to produce a portion of one of the outer shells of the main part 6 of the flip part 8. Whether the housing 16 is made as separate part or an integral part of one of the main part 6 or the flip part 8, the portion 30 then forms a convenient point of attachment to join with the other of the main part 6 and or the flip part 8. A similar portion could also extend from the shaft 14 out the opposite end of the shaft 14 to provide dual points of attachment. In the FIG. 2 preferred embodiment, a taper 32 on the end of the shaft 14 aids assembly. Assembly can be realized by simply placing the leaf spring 18 over the accommodation space, then sliding the shaft 14 into the housing 16 and attaching either the main part 6 or the flip part 8 to the portion 30. The taper 32 will compress the leaf spring 18 during the assembly to allow the shaft 14 to pass. When a preferred reduced diameter portion 34 of the shaft 14, i.e., the portion including the flattened portions 26 and the ridge 28 reach the leaf spring 18 (shown in FIG. 3 as having a smaller radius R2), the leaf spring 18 snaps back into the smaller diameter 34 and fixes the shaft 14 into its proper axial location relative to the housing 16. Assembly may be reversed when the shaft 14 is in a rotational position such that a second ridge 36 sufficiently deflects the leaf spring 18. The torque required deflect the leaf spring 18 into this position to accomplish disassembly should be great enough to avoid accidental disassembly. Rather high torque is preferably required to depress the spring 18 to overcome the ridge 35 and allow movement into a higher diametrical portion 38 of the shaft 14. The higher diametrical portion 38 (shown in FIG. 3 as having a radius R1>R2) is separated from the smaller diametrical portion 34 by the second ridge 36.

A fully assembled hinge 12 may complete attachment of the main part 6 and the flip part 8 by inserting the housing 16 into the opening 31. Opposite the opening, for example, may be an extension (unshown) to mate with one of two slots 38 on the main part 6. If the extension opposite the opening 31 is spring loaded, the portion 30 of the shaft may easily be fitted into the other of the slots 38 first. Any other techniques, e.g., elasticity in the slots 38 allowing their temporary deformation, is suitable to complete assembly.

While a specific embodiment of the present invention has been shown and others described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A wireless mobile communication device enclosure comprising:
a main part and flip part joined to permit opening and closing of the flip part;
a hinged connection joining said main part and said flip part to permit said opening and closing of the flip part, said hinged connection including
a housing defining a cylindrical opening therein;
an accommodation space within the cylindrical opening;
a leaf spring disposed over said accommodation space, said accommodation space being sufficient to permit deflection of said leaf spring;
cam shaft within said housing disposed deflect said leaf spring at some rotational positions of said cam shaft relative to said housing and to permit said leaf spring to relax at at least two distinct rotational positions of said cam shaft.

2. The wireless mobile communication device enclosure of claim 1, wherein said cam shaft includes:
at least two flattened portions on said cam shaft ending in a common ridge portion, the flattened portions and ridge being aligned with said leaf spring and said accommodation space;
rotational positions of said cam shaft aligning said flattened portions with said leaf spring permit said leaf spring to be completely undeflected; and
rotational positions of said cam shaft aligning said ridge with said leaf spring cause deflection of said leaf spring by contact with said ridge.

3. The wireless mobile communication device enclosure of claim 2, wherein said cam shaft includes a reduced diameter portion and said flattened portions and said ridge are part of said reduced diameter portion.

4. The wireless mobile communication device enclosure of claim 3, further comprising a second ridge separating said reduced diameter portion from a remaining larger diameter portion of said cam shaft.

5. The device enclosure of claim 2, wherein said ridge is rounded.

6. The device enclosure of claim 5, wherein said ridge extends over almost an entire length of said leaf spring.

7. The device enclosure of claim 2, wherein said shaft and said housing are plastic.

8. The device enclosure of claim 1, wherein a portion of said shaft extends beyond said housing to join with one of said main part and said flip part.

9. The device enclosure of claim 1, wherein said housing forms a separate part that may be inserted into an opening of one of said main part and said flip part.

10. The device enclosure of claim 1, wherein said accommodation space comprises a recess.

11. The device enclosure of claim 1, wherein said cam shaft includes a ridge to contact and deflect said leaf spring.

12. A wireless mobile communication device enclosure:
a main part and flip part joined to permit opening and closing of said flip part;
a hinged connection joining said main part and said flip part to permit said opening and closing of said flip part, said hinged connection including,
a housing defining a cylindrical opening therein;
a shaft closely accommodated with said housing;
a leaf spring between said housing and said shaft, wherein at least a portion of said shaft is configured to deflect said leaf spring at a first relative rotational position of said shaft and said housing, and to allow said leaf spring to relax at two additional relative rotational positions of said shaft and said housing.

13. The wireless mobile communication device enclosure according to claim 12, wherein said housing includes a recess for permitting said leaf spring to deflect, and a shelf formed around a circumference of said recess to hold said leaf spring in place.

14. The wireless mobile communication device enclosure according to claim 12, wherein said shaft includes a ridge to contact and deflect said leaf spring.

15. The wireless mobile communication device enclosure according to claim 14, wherein said ridge extends over the entire length of said leaf spring.

16. The wireless mobile communication device enclosure according to claim 12, wherein a portion of said shaft extends beyond said housing to connect with one of said main part or said flip part.

17. A wireless mobile communication device enclosure, comprising:
a main part;
a flip part;
a hinge part rotatably connecting said main part and said flip part, said hinge part comprising a housing rotatably accommodating a shaft over a leaf spring, the shaft being configured to deflect the leaf spring at least one predetermined rotational position and leave the leaf spring less deflected at other another predetermined rotational position.

18. The enclosure according to claim 17, wherein said shaft is configured to leave the leaf spring completely undeflected at said another predetermined rotational position.
